(19) United States
(12) Patent Application Publication
(10) Pub. No.: US 2006/0193287 A1
(43) Pub. Date: Aug. 31, 2006

(54) Wireless communication apparatus, communication system, communication method, and program

(76) Inventors: Satoru Ooshima, Tokyo (JP); Kohei Sekine, Tokyo (JP); Shinji Usui, Kanagawa (JP); Daisuke Tagami, Kanagawa (JP)

Correspondence Address: SONNENSCHEIN NATH & ROSENTHAL LLP;Sears Tower, P.O. Box 061080, Wacker Drive Station, Chicago, IL, 60606-1080, US

(21) Appl. No.: 11/361,557

(22) Filed: Feb. 23, 2006

(30) Foreign Application Priority Data
Feb. 28, 2005 (JP) P2005-053315
Feb. 28, 2005 (JP) P2005-053316
Feb. 28, 2005 (JP) P2005-053317

(51) Int. Cl. H04Q 7/00

(52) U.S. Cl. 370/328

(57) ABSTRACT

A wireless communication apparatus able to shorten a connection time between wireless communication apparatuses, including a wireless module activated after the end of download of firmware and becoming able to communicate with another apparatus for communication and a system control unit able to download the firmware after activation, wherein the wireless module includes a memory unit able to hold storage data even when power is turned off, and the system control unit downloads the firmware into the memory unit of the wireless module when the power of the wireless module is turned on and a communication system, a wireless communication method, and a program related to the same.

### CROSS REFERENCES TO RELATED APPLICATIONS

The present invention contains subject matter related to Japanese Patent Application No. 2005-053315, No. 2005-053316 and No. 2005-053317 filed in the Japan Patent Office on Feb. 28, 2005, the entire contents of which being incorporated herein by reference.

### BACKGROUND OF THE INVENTION

1. Field of the Invention

The present invention relates to a wireless communication apparatus, communication system, communication method, and program for communication between communication apparatuses in for example a wireless LAN (WLAN) system etc. In more detail, the present invention relates to technology for increasing the speed of connection between wireless communication apparatuses and a technique for improving power control in a mobile station engaged in wireless communication in for example the IEEE802.11 MAC specification infrastructure mode.

2. Description of the Related Art

In existing WLAN apparatuses, in general, in order to communicate with an access point (hereinafter sometimes also referred to as an “AP”) or a WLAN apparatus to be communicated with after activating the WLAN apparatus, the apparatus scans if there are access points AP for all channels prescribed in the IEEE802.11, then establishes the connection and enables communication. Accordingly, in existing WLAN apparatuses, in general, a certain degree of time is required from when the WLAN apparatus is activated to when the communication with the access point AP or the WLAN apparatus to be communicated with becomes possible.

FIG. 1 is a flow chart showing processing up to when the WLAN apparatus (station STA) can communicate with the access point AP. As shown in FIG. 1, first the system mounting the WLAN apparatus (module) is turned on and the parts of the system other than the WLAN apparatus are activated (booted up) (ST1). After the end of the system activation (boot), the system loads a driver for controlling the WLAN apparatus in a memory formed by for example a SRAM (ST2).

Next, the WLAN apparatus (module) is turned on and power is supplied (ST3), then WCPU use firmware (software: SW) in the WLAN apparatus is downloaded into the WLAN module from a host side (ST4)

After the end of download of the firmware, the WCPU performs initialization processing by the downloaded software SW and activates the WLAN module (ST5). Next, the station STA starts the processing for connecting the access point AP (ST6).

In order to connect to the access point AP, the system scans if there are access points AP for all channels prescribed in IEEE802.11 and establishes the connection (ST7) to enable communication.

When there is a mobile station STA shifting to the power control mode in a BSS forming the same wireless network, the access point AP buffers data frames directed to the station STA. Note that, here, a description of the detailed role of a general access point AP concerning the power control will be omitted.

The station STA becomes an activation state at a certain constant beacon timing interval. When detecting the existence of data directed to itself from traffic instruction message (TIM) information in the beacon transferred from the access point AP, the station STA can receive the data frames stored at the access point AP by transmitting a special control frame referred to as a PS-Poll frame.

Further, when receiving all data frames buffered at the access point AP, the station STA immediately enters a power saving state.

### SUMMARY OF THE INVENTION

In the method described above, however, considerable processing is necessary until the WLAN apparatus is activated, so a long time is taken. When it is desired to realize the all channel scan prescribed in the IEEE802.11 in order to scan which channels there are access points AP for after activation, a long time is taken for the channel scan, therefore there is the disadvantage that a long time is taken from the activation to the start of the connection.

Further, in the power control of the IEEE802.11 infrastructure mode, a great reduction of the power is realized, but there is the disadvantage that a reduction of the throughput is induced. The reason for this will be explained below.

As explained above, when there are a plurality of data frames buffered at the access point AP, the sequence of receiving data frames by the previous PS-Poll frame is repeated that number of times. As a result, when the number of data frames buffered at the access point AP is large, an overhead of transferring the number of data frames worth of PS-Poll frames occurs, so the throughput is lowered.

Further, the station STA immediately enters the power saving state when receiving all data frames buffered at the access point AP. For this reason, when the traffic of the data frames is in a burst-like state, the phenomenon that data frames whose access point AP should be transmitted immediately after the power saving state of the station STA are buffered again and not transferred until the station STA becomes the activation state occurs. As a result, a delay of that amount occurs, so a further reduction of the throughput is induced.

Therefore, in order to eliminate the overhead and the delay leading to the reduction of the throughput, there is the technique of omitting the PS-Poll frame for each data frame and waiting for data frames for a constant period without immediately entering the power saving state even when the data transfer is completed.

When realizing this technique, there is the effect of preventing the reduction of throughput, but when data traffic such as stream traffic typically occurs, an activation state time of the amount of a “wait for data frame” operation is generated, therefore conversely there is a defect of a reduction of the power saving effect.

As described above, in the related art, there is a tradeoff between “raising the power-saving effect” and “preventing a reduction of throughput”, that is, there are merits and demerits, so achieving both is difficult.

An object of the present invention is to provide a wireless communication apparatus, a communication system, a wireless communication method, and a program able to shorten the connection time between wireless communication apparatuses.

Another object of the present invention is to provide a wireless communication apparatus, a communication system, a wireless communication method, and a program able to realize both an improvement of the power saving effect and a prevention of reduction of the throughput.

According to a first aspect of an embodiment of the present invention, there is provided a wireless communication apparatus comprising a wireless module activated configured to be after an end of download of firmware and ready to communicate with another apparatus for communication; and a system control unit configured to download the firmware after activation; wherein the wireless module includes a memory unit configured to hold storage data even if power is turned off, and the system control unit downloads the firmware into the memory unit of the wireless module when the power of the wireless module is turned on.

According to a second aspect of an embodiment of the present invention, there is provided a wireless communication apparatus comprising a wireless control unit configured to perform scan processing for an access point after activation and connecting with an apparatus for communication; and a memory unit configured to hold previously set scan information; wherein the wireless control unit performs the scan processing based on the scan information.

According to a third aspect of an embodiment of the present invention, there is provided a wireless communication apparatus capable of shifting between an activation state and a power saving state, and wirelessly communicating data frames with an apparatus for communication; the apparatus having a stream mode performing processing corresponding to stream traffic and a burst mode performing processing corresponding to burst traffic; the apparatus comprising: a statistical processing unit configured to take statistics of history of time information of received data frames; a switch unit configured to judge, based on the statistical results of the statistical processing unit, whether traffic is a stream or burst, and selectively switching, in accordance with a result of the judgment, a mode to be processed between the stream mode and the burst mode; and a control unit configured to perform power control by switching a control mode, in accordance with the stream mode or the burst mode, which is selected by the switch unit.

According to a fourth aspect of an embodiment of the present invention, there is provided a communication system capable of wirelessly communicating with one or more other wireless communication apparatuses, wherein: each of the wireless communication apparatuses has a wireless module, which is activated after an end of download of firmware and becomes ready to communicate with another apparatus for communication; the wireless communication apparatus has a system control unit configured to download the firmware after the activation; the wireless module includes a memory unit configured to hold storage data even if a power is turned off; and the system control unit downloads the firmware into the memory unit of the wireless module if a power of the wireless module is turned on

According to a fifth aspect of an embodiment of the present invention, there is provided a communication system enabling communication of a plurality of wireless communication apparatuses, wherein: each of the wireless communication apparatuses has a wireless control unit configured to scan for an access point after an activation and connecting with an apparatus for communication; the wireless communication apparatus has a memory unit configured to hold previously set scan information; and the wireless control unit performs the scan processing based on the scan information.

According to a sixth aspect of an embodiment of the present invention, there is provided a communication system allowing communicate between a plurality of wireless communication apparatuses, wherein: each of the wireless communication apparatuses has a stream mode performing processing corresponding to stream traffic and has a burst mode performing processing corresponding to burst traffic; the wireless communication apparatus has a statistical processing unit configured to take statistics of history of time information of received data frames; a switch unit configured to judge, based on statistical results of the statistical processing, whether the traffic is a stream or burst, and selectively switching, in accordance with a result of the judgment, a mode to be processed between the stream mode and the burst mode; and a control unit configured to perform power control by switching a contorol mode, in accordance with the stream mode or the burst mode, which is selected by the switch unit.

According to a seventh aspect of an embodiment of the present invention, there is provided a communication method in a wireless communication apparatus for wirelessly communicating with one or more other wireless communication apparatuses, the method comprising the steps of: activating parts of the system other than a wireless module; turning a power of the wireless module; downloading firmware, for activating the wireless module, into a memory unit configured to hold storage data, even if the power is turned off; activating after an end of the download of the firmware; and communicating with an apparatus for communication after a scan operation.

According to an eighth aspect of an embodiment of the present invention, there is provided a communication method in a wireless communication apparatus for wirelessly communicating with one or more other wireless communication apparatuses, the method comprising the steps of: scanning an access point based on previously set scan information after activation; and, updating information in a memory unit before connection processing, when detecting an access point.

According to a ninth aspect of an embodiment of the present invention, there is provided a communication method in a wireless communication apparatus for wirelessly communicating with one or more other wireless communication apparatuses; the apparatus having a stream mode performing processing corresponding to stream traffic and a burst mode performing processing corresponding to burst traffic; the method comprising the steps of: taking statistics of a history of time information of received data frames; judging, based on the statistical results, whether traffic is a stream or burst; selectively switching, in accordance with a result of the judgment, a mode to be processed between the stream mode and the burst mode; and controlling by switching a control mode, in accordance with the stream mode or the burst mode, which is selected.

### BRIEF DESCRIPTION OF THE DRAWINGS

These and other objects and features of the present invention will become clearer from the following description of the preferred embodiments given with reference to the accompanying drawings, wherein:

FIG. 1 is a flow chart showing processing until a WLAN apparatus (station STA) becomes able to communicate with an access point AP;

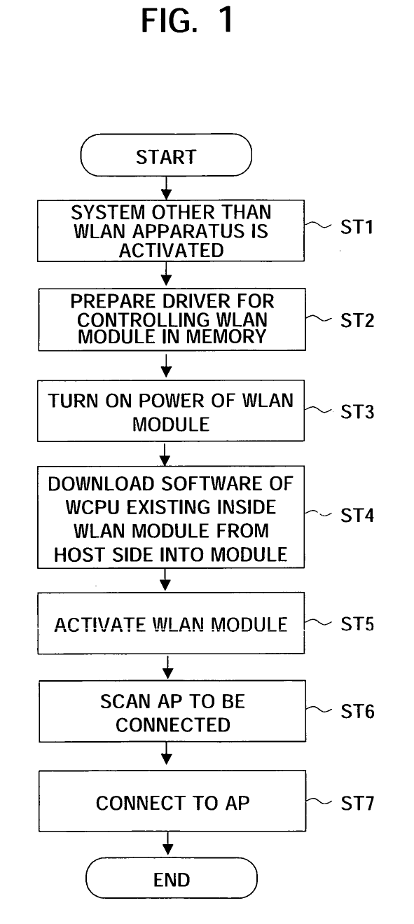

FIG. 2 is a view showing an example of the configuration of a communication system in the present embodiment;

FIG. 3 is a flow chart showing processing from system activation until connection with an access point is established in the present embodiment;

FIG. 4 is a flow chart showing an example of a scanning method of an access point AP after activating a WLAN module;

FIG. 5 is a view showing an example of the configuration of scan information of the present embodiment;

FIG. 6 is a flow chart for explaining a connection method for scanning an access point AP for which connection is previously predicted when a host control unit does not issue a connection request;

FIG. 7 is a flow chart showing a processing sequence when there are two scan information of a scanning method of an access point AP after activating the WLAN module;

FIG. 8 is a block diagram showing an example of the configuration of a power control system in a wireless unit according to the present embodiment;

FIG. 9 is a view showing sample data at the time of burst traffic in time sequence;

FIG. 10 is a view statistically showing sample data at the time of burst traffic;

FIG. 11 is a view showing sample data at the time of stream traffic in a time sequence;

FIG. 12 is a view statistically showing sample data at the time of stream traffic in a time sequence;

FIG. 13A to FIG. 13C are views showing images of frame exchange at the time of a burst mode; and

FIG. 14A to FIG. 14E are diagrams showing images of frame exchange at the time of a stream mode.

### DESCRIPTION OF THE PREFERRED EMBODIMENTS

Below, preferred embodiments will be described with reference to the accompanying drawings. Note that the embodiments will be explained by taking as an example the IEEE802.11 standard.

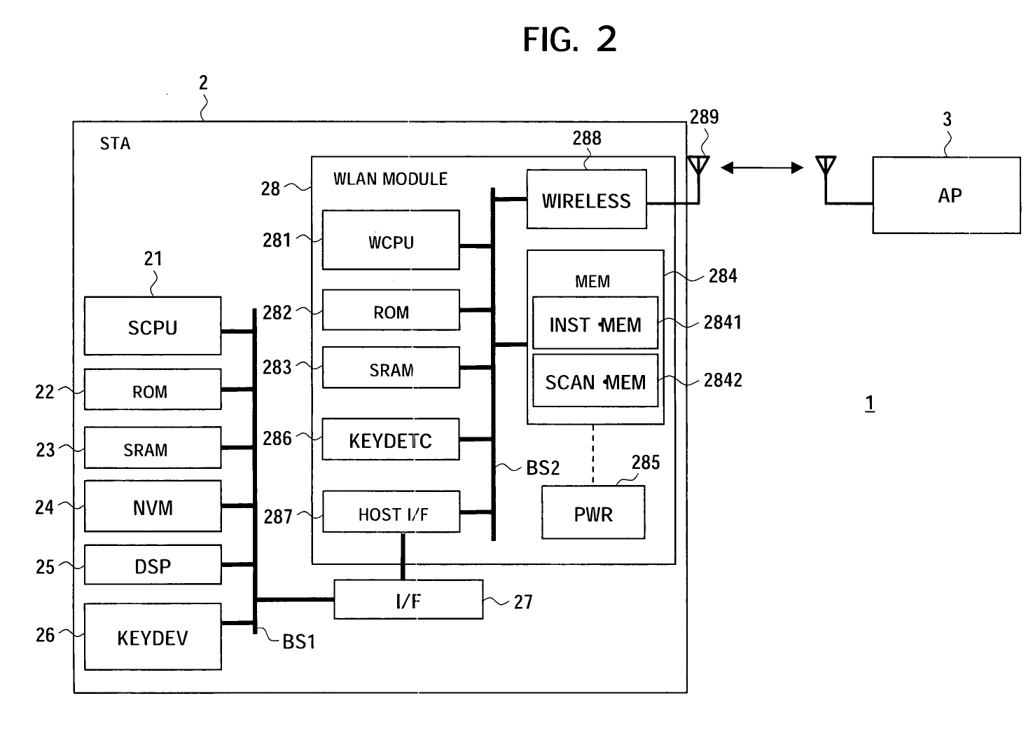

FIG. 2 is a block diagram showing an example of the configuration of a communication system in the present embodiment.

A communication system 1 of the present embodiment, as shown in FIG. 2, has a station (STA) 2 as a wireless communication terminal according to the IEEE802.11 standard and an access point (AP) 3 according to the IEEE802.11 standard. The station 2 and the access point 3 wirelessly communicate according to the IEEE802.11 standard.

The station 2, as shown in FIG. 2, has a system CPU (SCPU) 21 for controlling applications of the station 2, the WLAN, etc., a ROM 22, an SRAM 23, a nonvolatile memory device (NVM) 24, a display device (DSP) 25 such as an LCD, a key device (KEYDEV) 26 as an input portion, an interface circuit (I/F) 27, and a WLAN module 28 as a wireless module as principal components.

The system CPU 21, ROM 22, SRAM 23, nonvolatile memory device 24, LCD or other display device 25, and the key device 26 are connected to the interface circuit 27 by a bus BS1, and the interface circuit 27 is connected to the WLAN module 28.

The WLAN module 28, as shown in FIG. 2, has a WCPU 281 for controlling the operation in the WLAN module 28, a ROM 282, an SRAM 283, a memory unit (MEM) 284 made of a nonvolatile memory or an SRAM typically supplied with power, a power supply unit (PWR) 285, a key detection circuit (KEYDETC) 286, a host interface (Host I/F) 287 for transferring data with the system CPU 21 through the interface circuit 27, a wireless unit (WIRELESS) 288 for modulation/demodulation etc. for wireless communication with the access point 3, and an antenna 289 for transmitting and receiving electric waves.

The WCPU 281, ROM 282, SRAM 283, memory unit 284, key detection circuit 286, host interface (Host I/F) 287, and wireless unit 288 are connected by a bus BS2.

The memory unit 284 is configured by an instruction memory (INST MEM) 2841 and a scan information memory (SCAN MEM) 2842.

The communication system 1 of the present embodiment is configured so that the station 2 and the access point 3 wirelessly communicate as shown in FIG. 2. In the present embodiment, it is configured so as to improve the speed of activation (boot) of the WLAN module 28 and efficiency of the scan operation of the station 2. Note that in the communication system 1 of the present embodiment, no special software or hardware is required on the access point 3 side.

Below, an explanation will be given of a concrete technique for improving the speed of the activation (boot) of the WLAN module 28 and the efficiency of the scan operation of the station 2 in the present embodiment in sequence. Note that, in the following explanation, the access point is represented by the notation AP in some cases.

Overall Sequence

First, an explanation will be given of the improvement of the speed of activation (boot) of the WLAN module 28.

Basically, in the station 2, the system CPU 21 is activated, then the WLAN module 28 starts to be activated and the WLAN firmware stored in for example the SRAM 23 or the ROM 22 or the nonvolatile memory device 24 is downloaded. A very long time is taken in the download of the WLAN firmware here.

In order to shorten this time, the firmware may be previously downloaded during the operation of the system CPU 21.

Thereafter, even in the case where the power of the station 2 is turned OFF, by supplying power to only the memory unit 284 in the WLAN module 28 storing the software by the power supply unit 285, at the next time activation (boot), the download of the firmware is not necessary, so the time can be reduced.

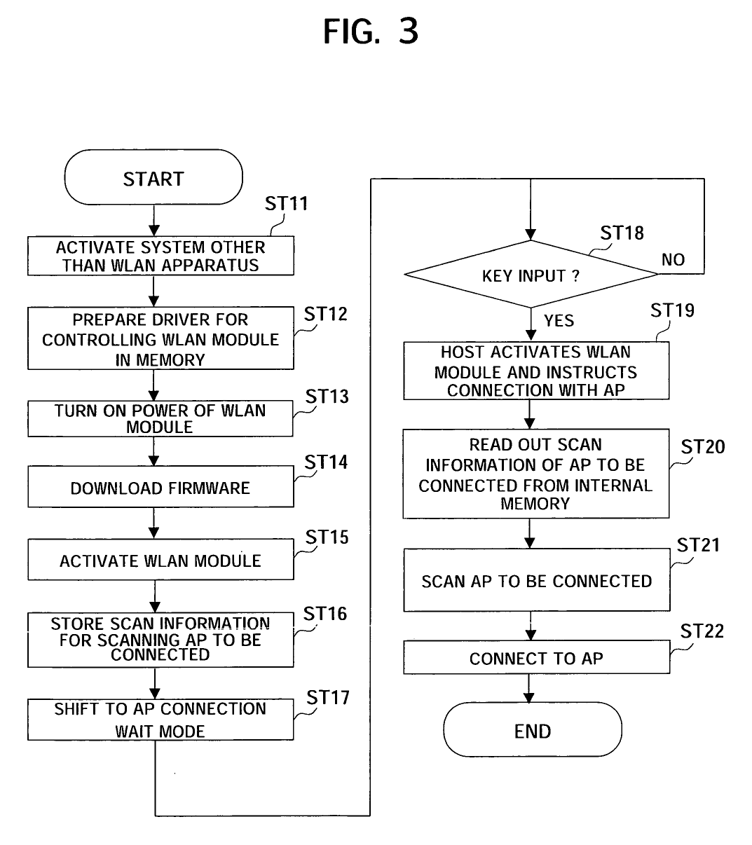

Next, an explanation will be given of the increase of the speed of the connection of the WLAN apparatus (module) with reference to FIG. 2 and FIG. 3.

FIG. 3 is a flow chart showing processing from the system activation until the connection with the access point 3 is established in the present embodiment.

The parts of the system other than the WLAN module are activated (ST11). Specifically, the system CPU 21 is activated first, then the driver for controlling the WLAN module 28 is stored in the memory, for example, the SRAM 23 (ST12).

Next, the power of the WLAN module 28 is turned on (ST13), then the firmware of WLAN is stored in the instruction memory (SRAM) 2841 of the memory unit 284 of the WLAN module 28 (ST14).

When the download of the firmware into the memory 2841 ends, the WLAN module 28 is activated by that firmware (ST15).

After the activation, the access points (AP) 3 are scanned, and the information of the access points AP existing in all channels are collected.

Next, the host control unit confirms the existence of the access point AP desired to be connected to from among collected access points (AP) 3.

When the desired access point AP exists, the control unit stores the information of the access point AP in the system side SRAM 23 or nonvolatile memory device 24 or stores it in the scan information memory 2842 in the memory unit 284 of the WLAN module 28 (ST16).

Finally, the routine proceeds to the connection wait mode (ST17). The connection wait mode is the mode in which the WLAN module 28 is in a sleep state and waiting for the connection command from the host control unit.

During the connection wait mode, the system CPU 21 detects when a key was operated by the key device 26 (ST18) and transfers the command for connection command packet transmission with the access point AP to the WLAN module 28 through the host interface 287 (ST19).

Next, the WCPU 281 in the WLAN module 28 wakes up the WLAN module.

Next, the connection command from the host control unit is sent to the WLAN module 28. The command carries the SSID (Service Set IDentity) of the access point AP to be connected to and selection information of the packet to be transmitted. By receiving this, the WCPU 281 shifts to the connection sequence.

The WCPU 281 reads out a program for scanning (scan) the access point AP stored in the instruction memory (SRAM) 2841 in the memory unit 284 (ST20) and scans for the access point AP to be connected to based on the read out scan information (ST21).

While this will be explained later, the scanning program has an algorithm for reducing the scan n time, the information of the access point AP and priority degree information stored in the scan information memory 2842 in the memory unit 284 are read out, and the scan is performed in the sequence of the degree of priority.

Finally, the access point AP is connected to (association) (ST22).

Increase of Speed of Firmware (FW) Download

Next, an explanation will be given of the increase of the speed of the download of the firmware.

Here, an explanation will be given of a case where the system CPU 21 realizes ultra-low power consumption, it is not necessary to boost down the power supply of the CPU, the system typically operates, the system CPU 21 can awake from the sleep state in a short time, the activation (boot) time of the CPU per se can be shortened, and the activation (boot) time of the system CPU 21 need not be concerned about.

In this case, the system CPU 21 is operating, therefore the download of the firmware is possible.

In the download of the firmware, the download time can be reduced by transferring already compressed firmware.

On the WLAN module 28 side, by giving decompression software to the ROM 282, giving a decompression engine in the form of hardware (HW), or downloading decompression software before downloading the firmware, the compressed firmware is decompressed.

Finally, the decompressed firmware initializes the module and the activation of the WLAN module 28 ends.

Further, as previously explained, sometimes the firmware is typically stored in the SRAM for use. Thereafter, it is connected in the same way as the case where the system CPU 21 is not activated.

As the compression method of the firmware, for example the Huffman method or LZW method can be applied.

Increase of Speed of Scan (Scan) of Access Points AP

Next, an explanation will be given of the increase of speed of the scan of the access points AP.

Scan Information and its Storage

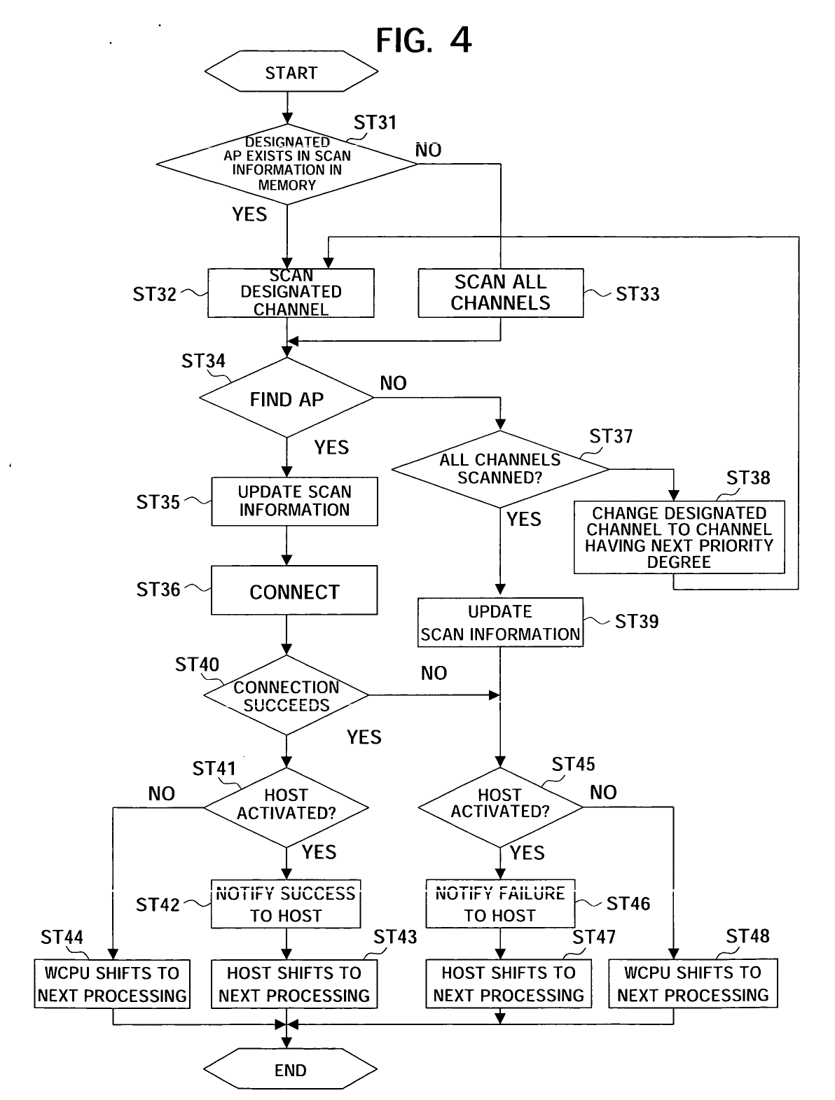

FIG. 4 is a flow chart showing an example of the method of scanning access points AP after activating the WLAN module.

After the WLAN module 28 of the station 2 is activated, the processing of steps ST31 to ST48 is carried out according to the flow chart shown in FIG. 4.

The WCPU 281 reads the existence of the scan information from the scan information memory (SRAM) 2842 of the memory unit 284 and designates the channel to be scanned.

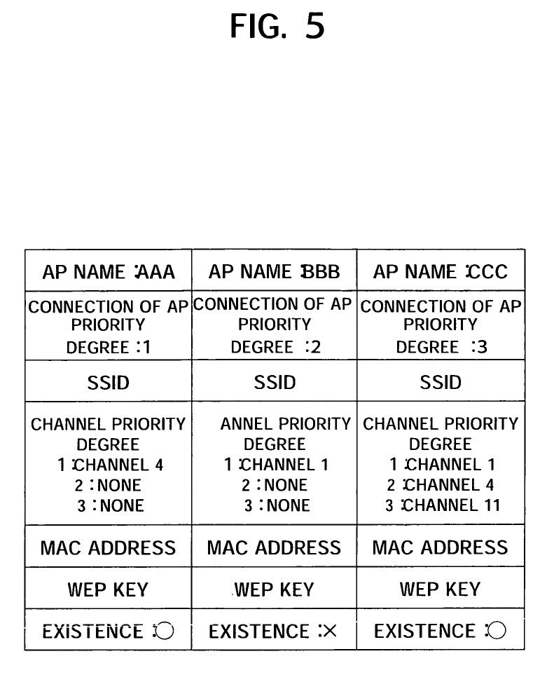

The scan information is the information of the access point AP to be connected to. This information is formed by the information of the access point AP, the degree of priority determined here, an existence flag, etc. as shown in FIG. 5 obtained at the time of the previous connection.

The contents of the information obtained from the access point AP are for example the SSID of the access point AP, the channel of the access point AP, the MAC address of the access point AP, and the WEP key as shown in FIG. 5.

When there is no scan information, the WCPU 281 shifts to the next processing or shifts to an instruction wait state from the host control unit.

The WCPU 281 scans and acquires the scan information and stores where the scan information exists. The method of storage and method of fetching the stored scan information include for example the following methods.

The first is the method of writing scan information into a nonvolatile memory connected to the WLAN module 28 and reading the same from the nonvolatile memory device 24.

The second is the method of writing the scan information into the nonvolatile memory device 24 connected to the host control unit and including it in the command for activating the WLAN module 28.

The third is a method of writing the scan information into the nonvolatile memory device 24 connected to the host control unit and downloading the scan information simultaneously with the download of the firmware from the host control unit when the WLAN module 28 employs the method of downloading the firmware from the host control unit.

Connection Method When Host Control unit Requests Connection and Scan Information of Access Point AP to be Connected to is Held in Memory

First, an explanation will be given of the scanning of the access point AP to be connected to.

The system CPU 21 as the host control unit requests connection by transferring the name of the access point AP to be connected to to the WLAN module 28.

The WCPU 281 scans if the information of the access point AP is present in the scan information memory (SRAM) 2842 of the memory unit 284 (ST31).

When the scan information of the access point AP to be connected to is present in the memory, a probe request frame is transmitted by using the SSID of the scan information, channel, and MAC address through the channel having the highest degree of priority written in the scan information, and the scan is carried out for only the designated channel in which the access point AP exists (ST32).

When the scan information does not exist in the memory, all channels are scanned (ST33).

As a result of the scan, the WCPU 281 receives the probe response frame from the access point AP. When detecting the access point AP (ST34), it shifts to the connection processing (ST35, ST36).

When the access point AP to be connected to cannot be detected, the WCPU 281 shifts to the next processing or shifts to a next instruction wait state from the host control unit (ST34 to ST39).

For example, the channel having the second highest degree of priority is scanned. Otherwise, the third and fourth candidate channels are scanned. When the access point AP can be detected by this, the scan information in the memory is updated, and the routine proceeds to the connection processing. When the access point AP cannot be detected even by this, “nonexistence” is held in the existence information in the scan information.

Next, an explanation will be given of the connection processing.

When the connection processing is carried out and the connection succeeds (ST40), the WCPU 281 shifts to the next processing or notifies the system CPU 21 as the host control unit that the connection succeeded and shifts to the next instruction wait state (ST41 to ST44).

When the connection fails (ST40), the WCPU 281 shifts to the next processing or shifts to the instruction wait state from the system CPU 21 as the host control unit (ST45 to ST48).

The WLAN module 28 holds the scanning result in the memory (SRAM) 2842 of the memory unit 284 in both of the case where the connection succeeded and the case where the connection failed, and the WCPU 284 or the system CPU 21 can read the information.

The WCPU 281 or the system CPU 21 can omit channels to be scanned by using this information as well. By omitting channels to be scanned, the scanning time is reduced. In comparison with the existing method, it becomes possible to reduce the time required for scanning to “1/number of all channels to be scanned”.

Further, a plurality of channels are not sent a radio wave, therefore, in comparison with the existing method, the traffic of the network is reduced. Even in the case where the connection by the scan information fails, the same processing as the existing method can be carried out.

Connection Method For Scanning Access Point AP Predicted to be Connected to in Advance When Host Control unit Does Not Issue Connection Request

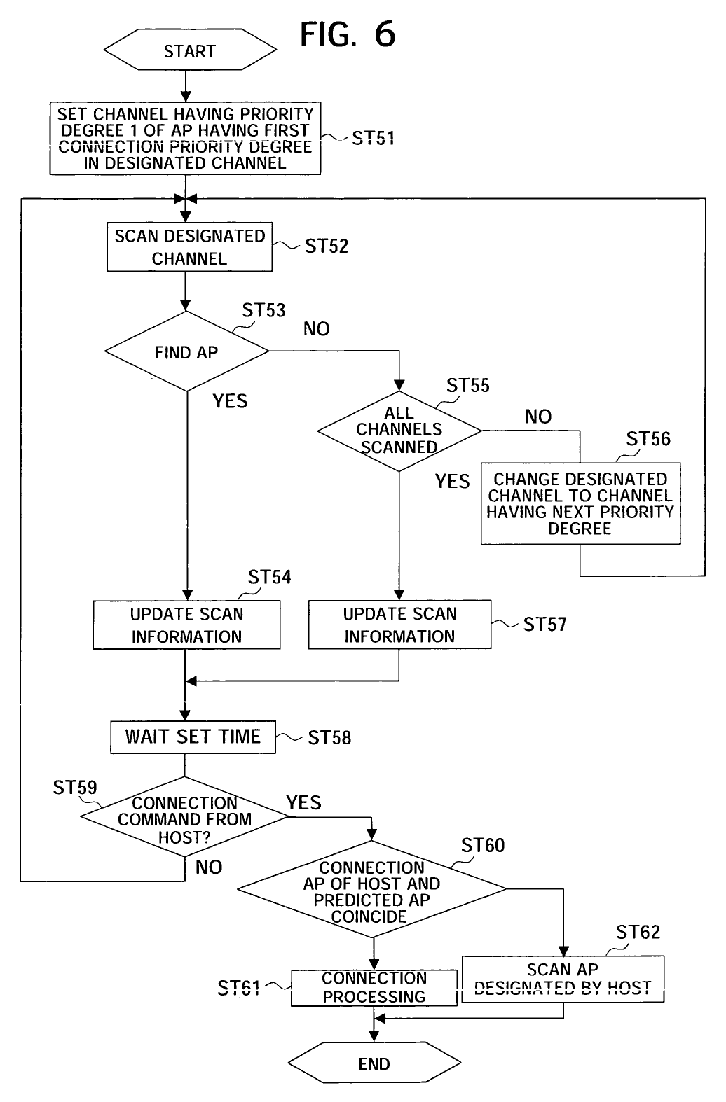

FIG. 6 is a flow chart for explaining the connection method for scanning the access point AP predicted to be connected to in advance when the host control unit does not issue a connection request.

Sometimes the WLAN module 28 starts up, but there is no connection request from the system CPU 21 as the host control unit.

In that case, the WCPU 281 predicts the access point AP designated from the system CPU 21 and previously fetches the newest scan information. First, the access point AP having the connection priority degree 1 in the memory is scanned. The scan at this time is carried out by the previously explained “connection method when the scan information of access point AP to be connected to by the host control unit exists”. When the scan information exists, the scan is periodically carried out by the channel of the newest SCAN information until the connection request from the system CPU 21 as the host control unit comes, and the newest state is confirmed (ST51 to ST59). This copes with the case where the access point AP dynamically changes in channel or the terminal moves, so the access point AP becomes unseen.

Finally, when the access point AP for which connection to is requested from the system CPU 21 as the host control unit and the access point AP predicted by the WCPU 281 coincide (ST60), the probe request frame is issued through the channel of the scan information and the connection request is issued. The WCPU 281 receives the probe response frame from the access point AP and, when detecting the access point AP, shifts to the connection processing (ST61).

When the request and the prediction do not coincide, the processing is carried out by the “connection method when the scan information of the access point AP to be connected to by the host control unit exists” explained above (ST62).

Connection Method when Scan Information has Plurality of Access Point AP Information when Predicting Connection Access PointAP

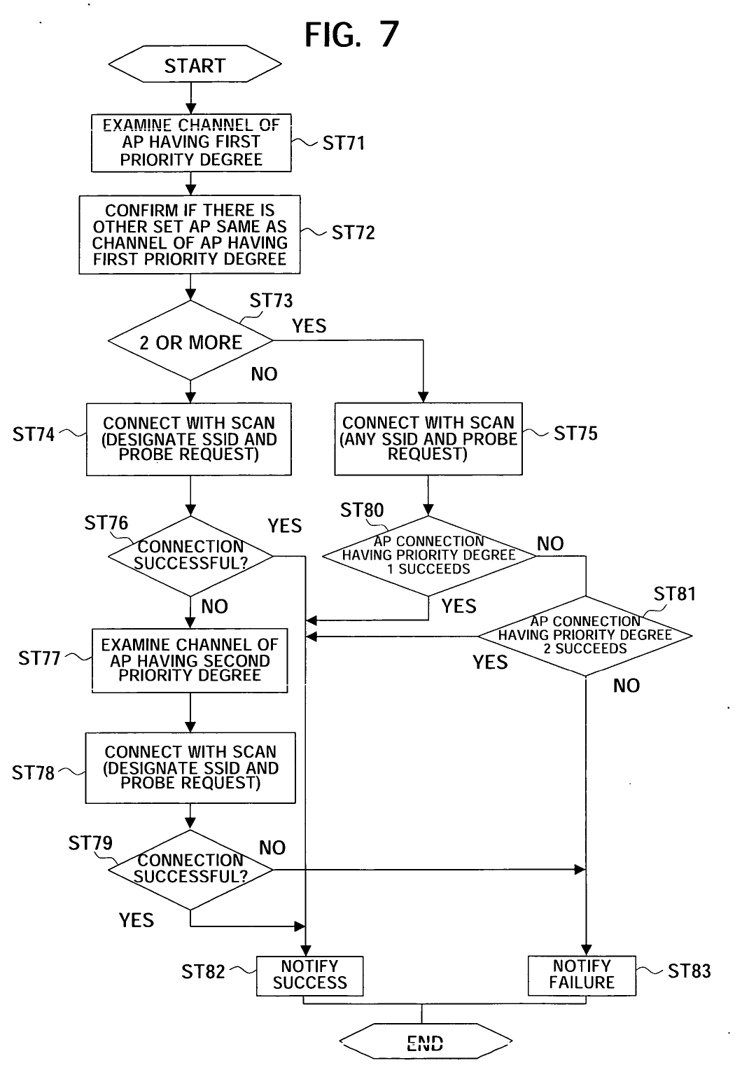

For example, when there are access points AP both at the home and office, the two access points AP differ in SSID and WEP key. In such case, the scanning time can be reduced by imparting a plurality of AP information to the SCAN information. In the WLAN module according to the present embodiment, an explanation will be given according to the flow chart shown in FIG. 7 assuming that there are two SCAN information.

In the flow of FIG. 7, the processing as explained below is carried out as in steps ST71 to ST83.

When there are a plurality of AP information, in the SCAN information, the priority degree information is provided in addition to the SSID, WEP key, and MAC address.

The WCPU 281 performs the scan in the sequence of the priority degree from the access point AP having the highest degree of priority when there is scan information and further there is a plurality of scan information. When finding an access point AP and succeeding in connection, no scan after that is carried out. When connection fails, the scanning shifts to the access point AP having the next highest degree of priority.

When scanning, the WCPU 281 determines the channel of the access point AP to be scanned in the sequence of the degree of priority and scans if there are access points AP having the same channel in the SCAN information.

The WCPU 281 transmits the probe request by using the already determined SSID when there are no access points AP of the same channel. When there are access points AP of the same channel, it transmits the probe request by the SSID any with respect to that channel (ST71 to ST75).

For example, when trying connection to an access point AP having the AP name AAA in FIG. 5, sometimes the channel having the first degree of priority of AAA becomes the channel 4, while the priority degree 2 of CCC also indicates the channel 4.

At this time, sometimes a plurality of responses are returned. For example, these are responses from the access points AP of AAA and CCC of FIG. 5. When responses are returned from a plurality of access points AP, the connection is tried with respect to the access point AP having the highest degree of priority among them. AAA is therefore connected to in FIG. 5.

When failing in connection, the connection is tried to the access point AP having the second highest degree of priority. Further, when responses are not returned from a plurality of access points AP and the response comes from the access point AP of CCC of FIG. 5, the connection can be made to CCC of channel 4, but the scan is not carried out with respect to BBB having the second highest priority degree, therefore the scan is carried out to BBB. When there is a response from the BBB, the connection is made to BBB, while when there is no response from BBB, the connection is made to CCC. Connection is not tried with respect to any access point AP which does not exist in the scan information (ST76 to St83).

In this way, by imparting the degree of priority, the connection can be sequentially carried out from the access point AP having the highest possibility of connection. By connecting from the access point AP having the highest possibility, the scanning time can be reduced. By simultaneously performing scanning of the same channels, the number of scans can be reduced, therefore the scanning time can be reduced.

Determination of Method of Generation and Priority Degree of Scan Information

Next, an explanation will be given of the method of generation of the priority degree of the scan information.

When the connection succeeds, the degree of priority of the access point AP successfully connected to at this time is set the highest. When there is the same access point AP in a list before that, the degree of priority of the old information is set low. In this case, it is also possible to delete the scan information.

This processing is carried out by the WCPU 281 when using the nonvolatile memory connected to the WLAN module 28, while is carried out by the system CPU 21 when using the nonvolatile memory device 24 connected to the system CPU 21 as the host control unit.

For example, in the state where the degrees of priority of the scan information SSID are

1: WLAN_A, 2: WLAN_B, 3: WLAN_C, 4: WLAN_D, when the station STA is connected to WLAN_C, the degrees of priority become as follows:

1: WLAN_C, 2: WLAN_A, 3: WLAN_B, 4: WLAN_D,

By generating degrees of priority in this way, the degree of priority of an access point AP having a higher possibility of connection can be made higher.

When giving a higher degree of priority to an access point AP having a higher possibility of connection, the scanning time can be reduced.

Further, the degrees of priority may be set to be programmable in advance. For example, in this time band, the degree of priority of WLAN_D is raised etc. Further, when position information is obtained, the degrees of priority are changed based on the position information etc.

As explained above, according to the present embodiment, in the station 2, the system CPU 21 is activated, then the activation of the WLAN module 28 is started and the WLAN firmware stored in for example the SRAM 23 is downloaded. At this time, power is supplied by the power supply unit 285 to only the memory unit 284 in the WLAN module 28. During the period when the system CPU 21 is operating, the WLAN firmware is downloaded to the memory unit 284. Thereafter, even when the power of the station 2 is turned off, the power is supplied by the power supply unit 285 to only the memory unit 284 in the WLAN module 28 storing the software, therefore it is not necessary to download the firmware when activating (boot) the next time, thus the time can be reduced.

Further, in the present embodiment, the firmware is compressed, therefore the download time can be shortened.

Further, according to the present embodiment, the scan information is stored in the memory unit 284, only specific channels are scanned, and only the specific channels can be scanned in the sequence of the priority degree, therefore the scanning time can be shortened.

Further, access points AP of the same channel are scanned all together, therefore the scanning time can be shortened also by this.

Further, the degree of priority can be set from the connection situation in the past, therefore the scanning time can be shortened also from this viewpoint.

In the above explanation, the concrete technique for improving the speed of activation (boot) of the WLAN module 28 and the efficiency of the scan operation of the station 2 in the present embodiment was explained.

Below, an explanation will be given of the concrete technique for improving power control in the communication system 1 of the present embodiment. In this case as well, the communication system 1 has the same configuration as that of FIG. 2.

In the communication system 1 of the present embodiment, the station 2 and the access point 3 wirelessly communicate as in FIG. 2, but the present embodiment is configured so that both an “improvement of the power saving effect” and “prevention of the reduction of throughput” can be achieved by improving the power control in the mobile station 2 engaged in wireless communication in the IEEE802.11 MAC standard infrastructure mode.

In the present embodiment, the power control is carried out by the following technique.

The station (STA) 2 becomes activated in a cycle of a certain constant beacon interval.

The station 2 transmits a NULL frame having a zero frame size making a power control bit of the MAC header “1” to the access point AP when in the activation state so as to inform it of the activation state.

The station 2 transmits a NULL frame having a zero frame size making the power control bit of the MAC header “0” to the access point AP before entering the power saving state so as to inform it of the power saving state.

The station 2 has a mode dedicated to processing for handling stream traffic (hereinafter described as the “stream mode”) and a mode dedicated to processing for handling burst traffic (hereinafter described as the “burst mode”).

In the present embodiment, the above power control is carried out at the wireless unit 288 of the wireless module 28.

As will be explained in detail later, the wireless unit 288 basically employs the following communication method and performs the power control so as to realize both “improvement of the power saving effect” and “prevention of the reduction of the throughput”.

The wireless unit 288 takes the statistics of the history of the time information of the received data frames and switches the power control method by judging whether the traffic is periodical (stream) or continuous (burst) from the statistical results.

The wireless unit 288 notifies the power control state to the access point AP by sending a dedicated frame when shifting to the activation state and the power saving state.

The wireless unit 288 waits for frames in the activation state as it is for the certain constant period immediately after the transfer of data frames at the time of the burst traffic so as to prevent the reduction of the throughput.

The wireless unit 288 connects with the access point AP at the time of stream traffic and changes the beacon interval so as to prevent the delay of the frames and realize more efficient power saving control.

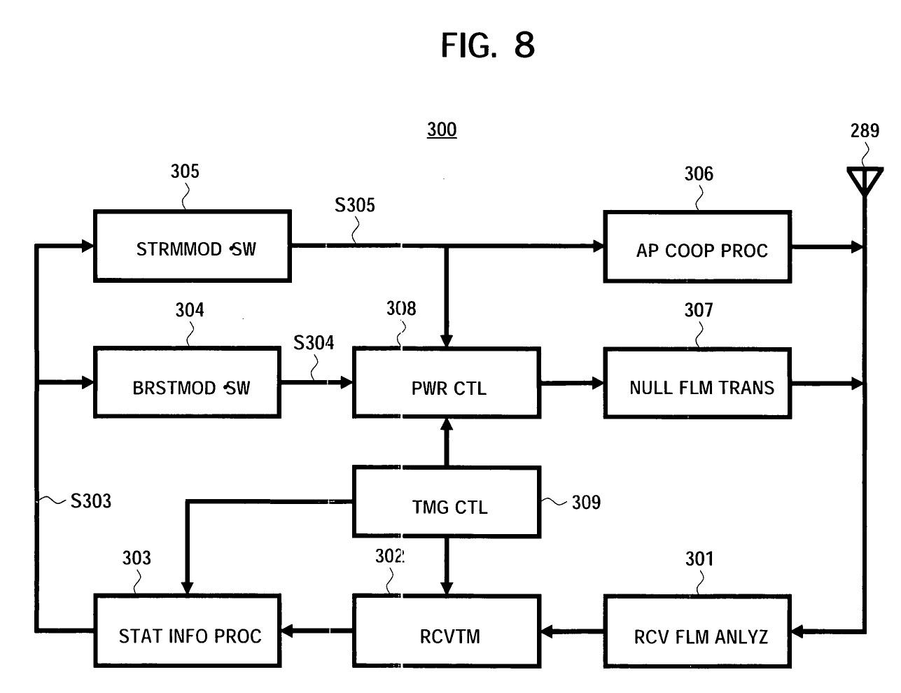

FIG. 8 is a block diagram showing an example of the configuration of the power control system in the wireless unit according to the present embodiment.

This power control system 300, as shown in FIG. 2, has a received frame analyzing unit (RCV FLM ANLYZ) 301, reception time memory unit (RCVTM) 302, statistical information processing unit (STATINFO PROC) 303, burst mode switch unit (BRST MOD SW) 304, stream mode switch unit (STRM MOD SW) 305, AP (access point) cooperation processing unit 306 (AP COOP PROC), NULL frame transmitting unit (NULL FLM TRANS) 307, power control unit (PWR CTL) 308, and timing control unit (TMG CTL) 309 as principal components.

When receiving the data frames through the antenna 289, the received frame analyzing unit 301 analyzes the received frames and stores the received time information in the reception time memory 302 as the reception time information database.

The reception time memory 302 functions as the reception time information database and outputs the stored reception time information to the statistical information processing unit 303 at a predetermined timing under the control of the timing control unit 309.

The statistical information processing unit 303 takes the statistics of the history of the time information from the reception time information stored in the reception time memory 303 by the processing as will be explained in detail later under the control of the timing control unit 309 and outputs the statistical results as a signal S303 to the burst mode switch unit 304 and the stream mode switch unit 305.

The burst mode switch unit 304 receives the statistical signal S303 of the statistical information processing unit 303, judges whether or not the traffic is the continuous burst mode, and outputs the signal 304 to the power control unit 308 so as to switch to the processing of the burst mode in the case of the burst mode.

The stream mode switch unit 305 receives the statistical signal S303 of the statistical information processing unit 303, judges whether or not the traffic is a periodical stream mode, and outputs the signal 305 to the power control unit 308 and the AP cooperation processing unit 306 so as to switch to the processing of the stream mode in the case of the stream mode.

The judgment of the mode based on the statistical results of the burst mode switch unit 304 and the stream mode switch unit 305 is carried out for example as follows.

The definition of the stream traffic is no (little) variation in received data frame intervals, therefore a threshold value of the standard deviation of the reception interval is previously provided, data having a variation that exceeds the threshold value is judged as burst traffic, and data traffic of the threshold value or less is judged as stream traffic.

The AP cooperation processing unit 306 receives the signal S305 of the stream mode switch unit 305, cooperates with the access point AP at the time of the stream traffic, and changes for example the beacon interval to thereby suppress the delay of the frames.

The NULL frame transmitting unit 307 transmits a NULL frame having a frame size of zero under the control of the power control unit 308. The NULL frame transmitting unit 307 transmits a NULL frame having a frame size of zero making the power control bit of the MAC header “1” to the access point AP when the WLAN module 28 of the station 2 is activated under the control of the power control unit 308 so as to inform it of the activation state. The NULL frame transmitting unit 307 transmits a NULL frame having a frame size of zero making the power control bit of the MAC header “0” to the access point AP before the WLAN module 28 of the station 2 enters the power saving state so as to inform it of the power saving state.

The power control unit 308 controls the transmission of the NULL frame of the NULL frame transmitting unit 307 at a predetermined timing controlled by the timing control unit 309 after determining the state of the traffic by the signal S304 from the burst mode switch unit 304 and the signal S305 from the stream mode switch unit 305.

The timing control unit 309 controls the storage of the reception time memory 302, the read timing, the statistics timing of the statistical information processing unit 303, and the control timing of the NULL frame transmission of the power control unit 308.

Below, an explanation will be given of the overall sequence of the communication system having the power control system of FIG. 8 of the present embodiment and the power control operation.

Overall Sequence

First, an explanation will be given of the overall sequence.

Basically, in the station 2, the system CPU 21 is activated, then the WLAN module 28 starts to be activated and the WLAN firmware stored in for example the SRAM 23 or the ROM 22 is downloaded.

The processing from the system activation to when the connection with the access point 3 is established in this case is basically carried out in the same way as the processing referred to in the flow chart of FIG. 3. Accordingly, there is an overlapped portion also here, but an explanation will be given with reference to the flow chart of FIG. 3.

As shown in FIG. 3, the parts of the system other than the WLAN module are activated (ST11). Specifically, the system CPU 21 is activated first, and the driver used for controlling the WLAN module 28 is stored in the memory, for example, the SRAM 23 (ST12).

Next, the power of the WLAN module 28 is turned on (ST13), and the firmware of the WLAN is stored in the instruction memory (SRAM) 2841 of the memory unit 284 of the WLAN module 28 (ST14).

When the download of the firmware into the memory 2841 ends, the WLAN module 28 is activated by that firmware (ST15).

When the WLAN module 28 of the station 2 becomes activated, the wireless unit 288 transmits a NULL frame having a frame size zero making the power control bit of the MAC header “1” to the access point (AP) 3 so as to inform it of the activation state.

After activation, the access points (AP) 3 are scanned, and information of access points AP existing in all channels are collected.

Next, the host control unit confirms the existence of the access point AP desired to be connected to among the collected access points (AP) 3.

When the desired access point AP exists, the information of the access point AP is stored in the system side SRAM 23 or nonvolatile memory device 24 and stored in the scan information memory 2842 in the memory unit 284 of the WLAN module 28 (ST16).

Finally, the routine proceeds to the connection wait mode (ST17). In the connection wait mode, the WLAN module 28 is in the sleep state and waits for a connection command from the host control unit.

During the connection wait mode, the system CPU 21 detects that a key was operated by the key device 26 (ST18) and transfers the command of the connection command packet transmission with the access point AP to the WLAN module 28 through the host interface 287 (ST19).

Next, the WCPU 281 in the WLAN module 28 wakes up the WLAN module.

Next, the connection command is sent to the WLAN module 28 from the host control unit. The command carries the SSID (Service Set IDentity) of the access point AP to be connected and the selection information of the packet to be transmitted. Upon receipt of this, the WCPU 281 shifts to the connection sequence.

The WCPU 281 reads out the program for scanning the access points AP stored in the instruction memory (SRAM) 281 in the memory unit 284 (ST20) and scans the access points AP (ST21).

Finally, the connection (association) of the access point AP is carried out (ST22).

When the connection is established, communication becomes possible, and the packets are transferred.

Power Control

When receiving the data frames at the received frame analyzing unit 301 of the wireless unit 288, the WLAN module 28 of the station 2 stores the information of the received time in the reception time memory 302 as the reception time information database.

Then, under the control of the timing control unit 309, the statistical information processing unit 303 obtains statistics from the reception time information stored at a certain constant timing.

The burst mode switch unit 304 and the stream mode switch unit 305 judge whether the type of the traffic is a stream or burst type from the statistical results at the present point of time. From the judgment result, the processing is switched to either of the stream mode or the burst mode.

As the technique for deciding the traffic from the statistical results, the technique as explained above is applied.

Namely, the definition of the stream traffic is no (little) variation in received data frame intervals, therefore a threshold value of the standard deviation of the reception interval is previously provided, data having variation that exceeds the threshold value is identified as burst traffic, and data traffic of the threshold value or less is defined as stream traffic.

A concrete example will be explained below.

The time information of reception data frames for a certain constant period is acquired, and the time between reception data frames is found.

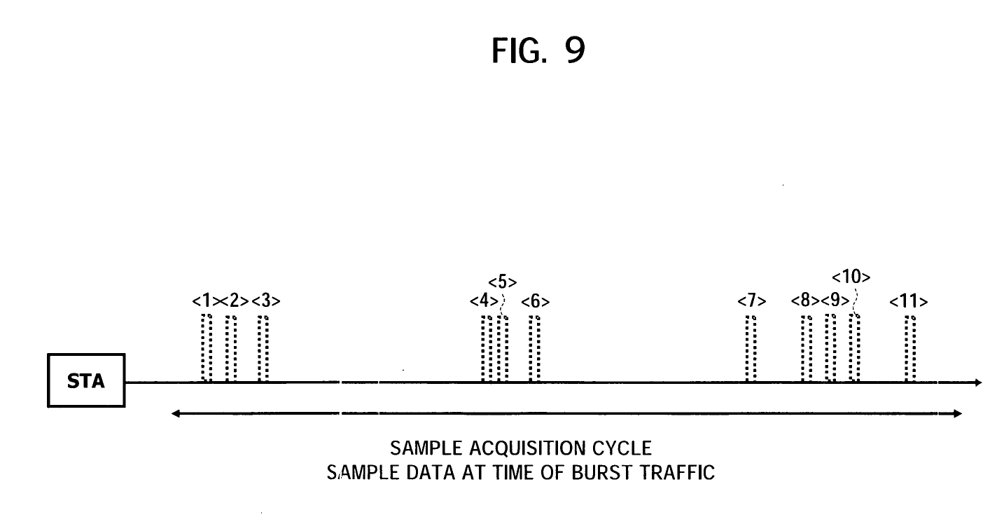

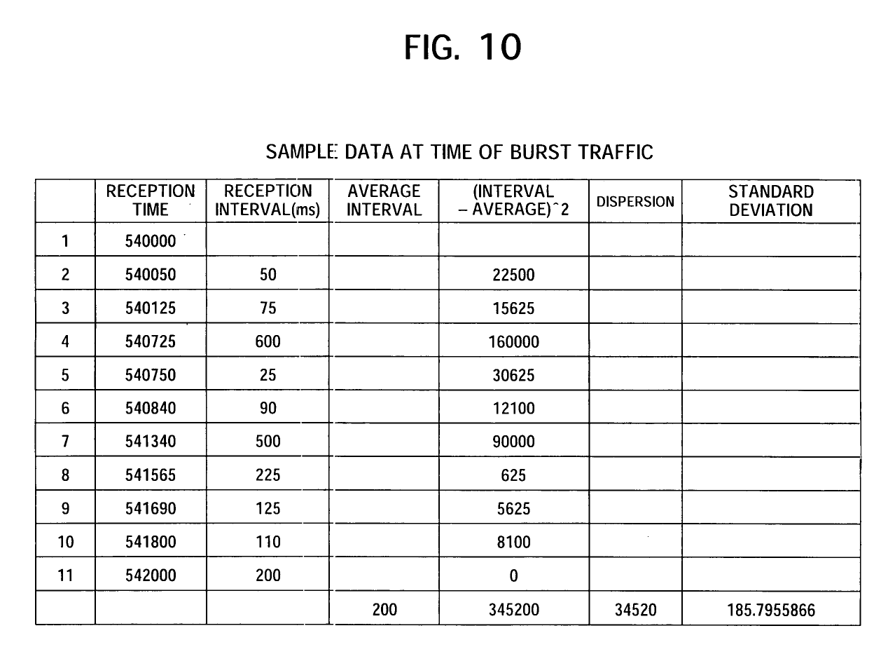

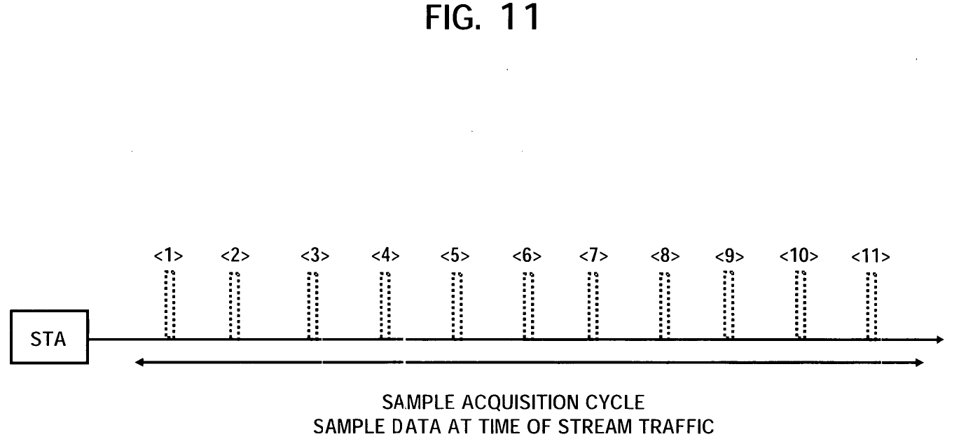

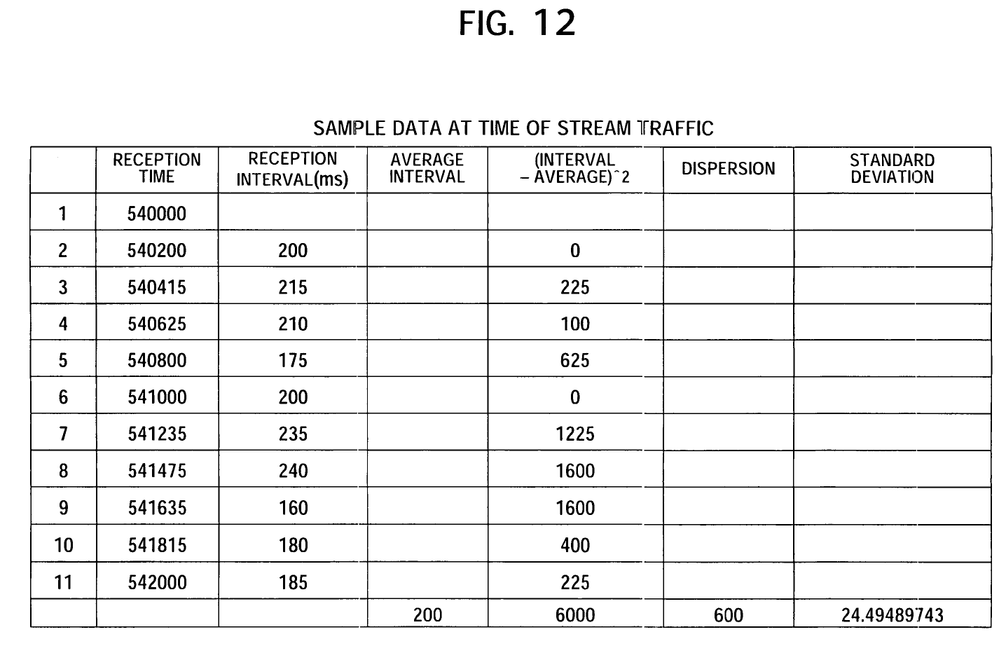

FIG. 9 and FIG. 10 are views showing sample data at the time of the burst traffic, and FIG. 11 and FIG. 12 are views showing the sample data at the time of the stream traffic. FIG. 9 and FIG. 11 indicate the sample data in a time sequence manner, and FIG. 10 and FIG. 12 indicate the same as statistical tables.

Both samples are data traffic where the reception interval becomes 200 ms.

In the sample data shown in FIG. 9 and FIG. 10, the variation of reception intervals is large, so the standard deviation is high, and the traffic is decided as burst traffic since it exceeds the previously determined threshold value.

On the other hand, in the samples shown in FIG. 11 and FIG. 12, the variation of reception intervals is small, so the standard deviation is low, therefore the traffic is judged as stream traffic since it does not exceed the previously determined threshold value. By the same method, it is also possible for the access point (AP) 3 to judge the type of the traffic by using the transmission data interval.

In the burst mode, there are a period during which data frames are continuously transferred and a period for which data frames are not transferred for a while.

As the basic operation, a technique not lowering the throughput is applied. The station 2 side employs a method of notifying the switch of the activation state and the power saving state to the access point AP by using a dedicated frame such as the previously explained NULL frame at the time of the switch.

By configuring the system in this way, data frames stored in the buffer of the access point (AP) 3 during the power saving state can be received when the activation state is exhibited.

Even after receiving data frames buffered in the access point (AP) 3, the WLAN module 28 of the station 2 remains in the activation state, therefore can subsequently receive the following data frames stored at the access point (AP) 3.

After a required sufficient waiting time, the WLAN module 28 of the station 2 transmits the previously explained NULL frame to the access point (AP) 3 so as to inform it of the power saving state.

As the required sufficient waiting time, the following example can be explained.

The waiting time is computed according to the traffic state until a fixed number of times worth of deacons are received. The required sufficient waiting time is the time until the waiting time has passed.

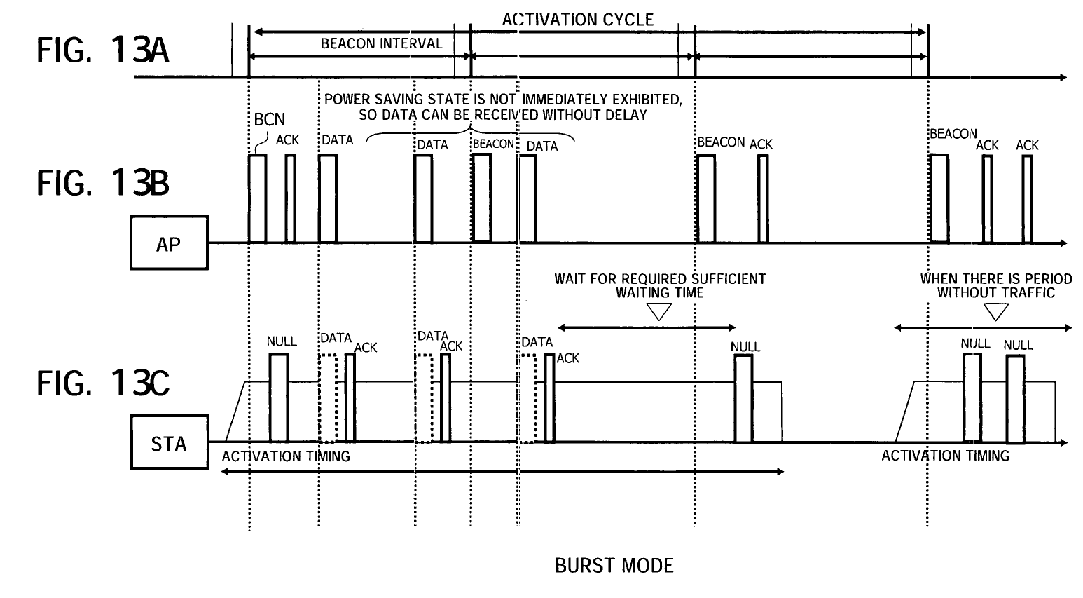

FIGS. 13A to 13C are views showing images of the frame exchange at the time of the burst mode.

In the figure, BCN indicates a beacon. As shown in FIG. 13B, the access point AP does not immediately enter the power saving state, therefore can receive the data without delay. Further, it has a required sufficient waiting time.

The station STA transmits the NULL frame at the activation timing.

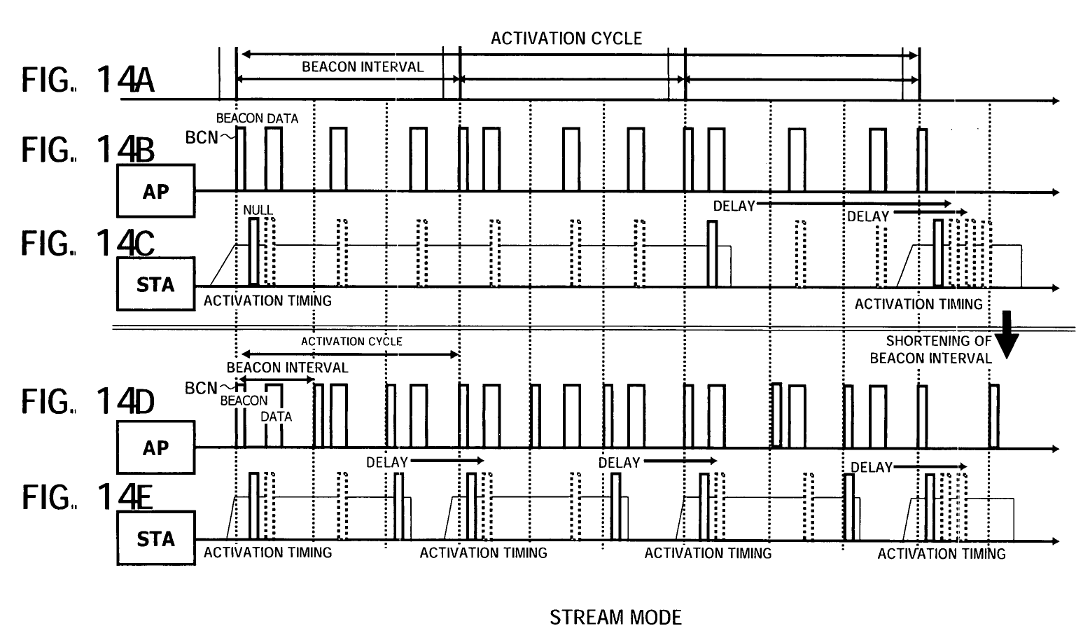

Further, FIGS. 14A to 14E are views showing images of the frame exchange at the time of the stream mode.

In the stream mode, data frames are transferred at a certain constant cycle. The basic operation is based on the above burst mode, therefore the STA transmits the NULL frame to the access point (AP) 3 as the means for notifying the activation state or power saving state to the access point (AP) 3.

By configuring the system in this way, the data frames stored at the access point (AP) 3 during the power saving mode can be received when the station enters the activation state.

Even after data frames buffered at the access point (AP) 3 are received, the WLAN module 28 of the station 2 remains in the activation state as it is, therefore can subsequently receive the following data frames stored at the access point (AP) 3.

However, when the activation time is the same as that in the burst mode, the station must continue in the activation state in order to receive the data frames coming at the constant intervals at the time of the stream traffic, therefore the efficiency of the power saving mode sometimes falls, so preferably the power is controlled so that the activation state is exhibited in a more suitable activation cycle and the power saving state is smoothly exhibited after the completion of the transfer.

The wireless unit 288 in the WLAN module 28 of the station 2 obtains the statistical information of the traffic from the received data frames as previously explained, therefore can determine the optimum activation cycle.

Therefore, by cooperating with the access point (AP) 3, the station 2 changes the interval of beacons transferred from the access point (AP) 3 so that data frames are included in the beacon interval at least one time.

By configuring the system in this way, the activation cycle on the station 2 side becomes the optimum, therefore, as seen also from FIGS. 14A to 14E, communication reduced in the delay of reception and holding a real time property becomes possible, and the power saving effect rises.

Conversely, by incorporating the method of judgment of the previous traffic by using the transmission data frame interval, the access point (AP) 3 can also determine the optimum beacon interval.

For this reason, the technique of changing the beacon interval without confirmation to the station 2 from the access point (AP) 3 can be employed.

As explained above, provision is made of the wireless unit 288 for switching the power control method by obtaining the statistics of the history of the time information of received data frames and judging whether the traffic is periodic (stream) or continuous (burst) from the statistical results, notifying the power control state by sending the dedicated frame when shifting to the activation state and the power saving state, waiting for the frame in the activation state as it is for a certain constant time immediately after the transfer of the data frames at the time of the burst traffic, preventing the reduction of the throughput, cooperating with the access point AP at the time of the stream traffic, and changing the beacon interval, therefore both improvement of the power effect and prevention of reduction of the throughput can be realized.

As a result, further, the following effects can be obtained.

The state of the traffic of the network is determined, and the optimum processing mode can be selected for a variety of traffic.

At the time of burst traffic, the system is operating in the mode dedicated to burst traffic, therefore efficient power saving can be carried out in a state where almost no reduction of throughput occurs.

At the time of stream traffic, the system is operating in the dedicated stream mode, therefore efficient power saving can be achieved in a state where almost no reduction of throughput occurs.

At the time of stream traffic, the system is operating in the stream dedicated mode, therefore the extent of the delay of the transfer can be reduced.

Note that the above processing is recorded on a floppy disk, a hard disk, an optical disk, a semiconductor memory, etc. as a program which can be processed by a computer, read out by a terminal, and executed.

It should be understood by those skilled in the art that various modifications, combinations, sub-combinations and alterations may occur depending on design requirements and other factors insofar as they are within the scope of the appended claims or the equivalents thereof.

What we claim is:

1. A wireless communication apparatus comprising:
a wireless module configured to be after an end of download of firmware and ready to communicate with another apparatus for communication; and
a system control unit configured to download the firmware after activation; wherein
the wireless module includes a memory unit configured to hold storage data even if power is turned off, and
the system control unit downloads the firmware into the memory unit of the wireless module when the power of the wireless module is turned on.

2. A wireless communication apparatus as set forth in claim 1, wherein: the memory unit stores and holds downloaded firmware even if the power of the wireless module is turned off.

3. A wireless communication apparatus as set forth in claim 1, wherein:
the system control unit downloads compressed firmware into the memory unit; and
the wireless module has a function of decompressing the compressed firmware.

4. A wireless communication apparatus comprising:
a wireless control unit configured to perform scan processing for an access point after activation and connecting with an apparatus for communication; and
a memory unit configured to hold previously set scan information; wherein
the wireless control unit performs the scan processing based on the scan information.

5. A wireless communication apparatus as set forth in claim 4, wherein: if the wireless control unit detects an access point, the wireless control unit updates the scan information in the memory unit before performing processing for the connection.

6. A wireless communication apparatus as set forth in claim 4, wherein: the wireless control unit stores scan results in the memory unit.

7. A wireless communication apparatus as set forth in claim 4, wherein: the wireless control unit scans access points of the same channel in the scan information all together.

8. A wireless communication apparatus as set forth in claim 4, wherein: if when the scan information includes a plurality of access points, the wireless control unit scans the plurality of access points in a preset order of priority.

9. A wireless communication apparatus as set forth in claim 4, wherein: the wireless control unit scans only specific channels in order of priority if scan information relating to a designated access point is present in the memory unit.

10. A wireless communication apparatus as set forth in claim 8, wherein: the wireless control unit sets the highest priority on an access point at which connection is made successfully.

11. A wireless communication apparatus as set forth in claim 9, wherein: the wireless control unit sets the highest priority on an access point at which connection is made successfully.

12. A wireless communication apparatus capable of shifting between an activation state and a power saving state, and wirelessly communicating data frames with an apparatus for communication;
the apparatus having a stream mode performing processing corresponding to stream traffic and a burst mode performing processing corresponding to burst traffic;
the apparatus comprising:
a statistical processing unit configured to take statistics of history of time information of received data frames;
a switch unit configured to judge, based on the statistical results of the statistical processing unit, whether traffic is a stream or burst, and selectively switching, in accordance with a result of the judgment, a mode to be processed between the stream mode and the burst mode; and
a control unit configured to perform power control by switching a control mode, in accordance with the stream mode or the burst mode, which is selected by the switch unit.

13. A wireless communication apparatus as set forth in claim 12, wherein:
the apparatus further has a transmitting unit configured to send a dedicated frame; and
the control unit contorols the transmitting unit to transmit a dedicated frame so as to notify a state of power control if shifting is made between the activation state and the power saving state.

14. A wireless communication apparatus as set forth in claim 13, wherein: the control unit contorols the transmitting unit to transmit a NULL frame having a zero frame size with setting of data showing the activation state if the activation state is set.

15. A wireless communication apparatus as set forth in claim 13, wherein: the control unit contorols the transmitting unit to transmit a NULL frame having a zero frame size with setting of data showing the power saving state if the power saving state is set.

16. A wireless communication apparatus as set forth in claim 12, wherein: in the burst traffic, the control unit waits for frames for a present period immediately after transfer of data frames while keeping activation state.

17. A wireless communication apparatus as set forth in claim 12, further comprising: an alliance processing unit configured to operate in connection with an apparatus to be communicated with and change an interval of a beacon signal to be transmitted at the time of stream traffic.

18. A communication system capable of wirelessly communicating with one or more other wireless communication apparatuses, wherein:
each of the wireless communication apparatuses has
a wireless module, which is activated after an end of download of firmware and becomes ready to communicate with another apparatus for communication;
the wireless communication apparatus has a system control unit configured to download the firmware after the activation;
the wireless module includes a memory unit configured to hold storage data even if a power is turned off; and
the system control unit downloads the firmware into the memory unit of the wireless module if a power of the wireless module is turned on.

19. A communication system enabling communication of a plurality of wireless communication apparatuses, wherein:
each of the wireless communication apparatuses has a wireless control unit configured to scan for an access point after an activation and connecting with an apparatus for communication;
the wireless communication apparatus has a memory unit configured to hold previously set scan information; and
the wireless control unit performs the scan processing based on the scan information.

20. A communication system as set forth in claim 19, wherein:
if the scan information includes a plurality of access points, the wireless control unit scans the plurality of access points in a preset order of priority; and
the wireless control unit scans only specific channels in order of priority if scan information relating to a designated access point is present in the memory unit.

21. A communication system as set forth in claim 20, wherein:
the wireless control unit sets the highest priority to an access point at which succeeded in connection; and
the wireless control unit sets a lower priority, if there is no access point in a channel at which succeeded in connection with a previous access point to the channel.

22. A communication system allowing communicate between a plurality of wireless communication apparatuses, wherein:
each of the wireless communication apparatuses has a stream mode performing processing corresponding to stream traffic and has a burst mode performing processing corresponding to burst traffic;
the wireless communication apparatus has a statistical processing unit configured to take statistics of history of time information of received data frames;
a switch unit configured to judge, based on statistical results of the statistical processing, whether the traffic is a stream or burst, and selectively switching, in accordance with a result of the judgment, a mode to be processed between the stream mode and the burst mode; and
a control unit configured to perform power control by switching a contorol mode, in accordance with the stream mode or the burst mode, which is selected by the switch unit.

23. A communication method in a wireless communication apparatus for wirelessly communicating with one or more other wireless communication apparatuses, the method comprising the steps of:
activating parts of the system other than a wireless module;
turning a power of the wireless module;
downloading firmware, for activating the wireless module, into a memory unit configured to hold storage data, even if the power is turned off;
activating after an end of the download of the firmware; and
communicating with an apparatus for communication after a scan operation.

24. A communication method in a wireless communication apparatus for wirelessly communicating with one or more other wireless communication apparatuses, the method comprising the steps of:
scanning an access point based on previously set scan information after activation; and,
updating information in a memory unit before connection processing, when detecting an access point.

25. A communication method in a wireless communication apparatus for wirelessly communicating with one or more other wireless communication apparatuses;
the apparatus having a stream mode performing processing corresponding to stream traffic and a burst mode performing processing corresponding to burst traffic;
the method comprising the steps of:
taking statistics of a history of time information of received data frames;
judging, based on the statistical results, whether traffic is a stream or burst;
selectively switching, in accordance with a result of the judgment, a mode to be processed between the stream mode and the burst mode; and
controlling by switching a control mode, in accordance with the stream mode or the burst mode, which is selected.

26. A computer program written in a computer readable format to be run on a computer, the program configured to enable a processing in a wireless communication apparatus for wirelessly communicating with one or more other wireless communication apparatuses, the processing comprising the steps of:
activating parts of the system other than a wireless module;
turning a power of the wireless module;
downloading firmware, for activating the wireless module, into a memory unit configured to hold storage data, even if the power is turned off;
activating after an end of the download of the firmware; and
communicating with an apparatus for communication after a scan operation.

27. A computer program written in a computer readable format to be run on a computer, the program configured to enable a processing in a wireless communication apparatus for wirelessly communicating with one or more other wireless communication apparatuses, the processing comprising the steps of:
scanning an access point based on previously set scan information after activation; and, updating scan information in a memory unit before connection processing, when detecting an access point.

28. A computer program written in a computer readable format to be run on a computer, the program configured to enable a processing in a wireless communication apparatus for wirelessly communicating with one or more other wireless communication apparatuses;
the apparatus having a stream mode performing processing corresponding to stream traffic and a burst mode performing processing corresponding to burst traffic;
the processing comprising the steps of:
taking statistics of history of time information of received data frames;
judging, based on the statistical results, whether traffic is a stream or burst;
selectively switching, in accordance with a result of the judgment, a mode to be processed between the stream mode and the burst mode; and
controlling by switching a control mode, in accordance with the stream mode or the burst mode, which is selected.
